(19) United States
(12) Patent Application Publication
(10) Pub. No.: US 2025/0062550 A1
(43) Pub. Date: Feb. 20, 2025

(54) Connection Device For Connecting A Conductor End

(71) Applicant: Weidmüller Interface GmbH & Co. KG, Detmold (DE)

(72) Inventors: Usman SHAHID, Detmold (DE); Jörg MÜNSTERMANN, Schlangen (DE); Heike SCHMIDTPOTT, Bad Salzuflen (DE)

(21) Appl. No.: 18/793,132

(22) Filed: Aug. 2, 2024

(30) Foreign Application Priority Data
Aug. 4, 2023 (DE) 102023120801.2

(51) Int. Cl. H01R 4/48; H01R 9/24

(52) U.S. Cl. CPC H01R 4/4811; H01R 4/484; H01R 9/2416

(57) ABSTRACT

A connection device for connecting a conductor end includes a housing with a rear wall and a front wall, a busbar arranged in the housing and a V-shaped clamping spring arranged in the housing. The clamping spring has a supporting leg supported on an abutment, a clamping leg and a spring rear connecting the two legs. A conductor insertion channel is configured in the housing, by which a conductor end to be connected can be guided into a contacting space between the front wall and the rear wall. The housing further has a receiving chamber open toward the front wall of the housing for inserting and receiving the clamping spring. A housing attachment overlapped by the clamping spring is configured in the receiving chamber and the clamping spring is at least positively secured toward the front wall against falling out of the receiving chamber by a clamping spring retaining mechanism integrated into the housing, including in a state in which the clamping leg has been moved into an open position.

### BACKGROUND

The invention relates to a connection device for connecting a conductor end.

Such a connection device is known from DE 10 2011 055 919 A1.

DE 10 2013 108 952 A1 discloses providing a cover on an actuator for actuating a clamping a spring of a connection device. The cover is intended to prevent mismating multi-stranded conductors and additionally to secure the clamping spring laterally in the housing, wherein the cover is molded latterly on the actuator.

There is a need for the generic connection device of DE 10 2011 055 919 A1 to be improved such that the clamping spring is particularly well secured in a structural manner against falling out of the housing.

### SUMMARY OF THE INVENTION

Accordingly, it is an object of the present disclosure to provide a connection device for connecting a conductor end, including a housing with a rear wall and a front wall, a busbar arranged in the housing and a V-shaped clamping spring arranged in the housing. The clamping spring has a supporting leg supported on an abutment, a clamping leg, and a spring rear connecting the two. A conductor insertion channel is configured in the housing, by which a conductor end to be connected can be guided into a contacting space between the front wall and the rear wall. The housing further has a receiving chamber open toward the front wall of the housing for inserting and for receiving the clamping spring. There is also a housing attachment that is overlapped by the clamping spring and configured in the receiving chamber. The clamping spring is positively secured against falling out of the receiving chamber toward the front wall at least by a clamping spring retaining mechanism integrated into the housing, including when the spring is in a state in which the clamping leg has been moved into an open position or respectively tensioned. This open position is a position in which the clamping spring would otherwise align with the contour of the receiving opening.

The clamping spring is thus well secured against falling out of the housing in a structurally simple way. It is particularly advantageous and secure for the clamping spring retaining mechanism to be integrated into the housing and not be arranged on a moving part such as the actuating pusher element.

In this respect, it is preferable and simple if the clamping spring retaining mechanism is integrally embodied with the housing. However, it can also be produced separately and attached to the housing and fastened thereto, for example in an adhesive or clamping manner.

According to a secure development which can be easily implemented in practice, the clamping spring retaining mechanism is embodied as a wall section of the housing, which is directly connected to the front wall and which secures the clamping spring on a narrow side against falling out of the housing. The spring is preferably produced from sheet metal.

However, according to another secure development which can be easily implemented, the clamping spring retaining mechanism can also be embodied as a wall section of the housing, which is, in other respects, not directly connected to the front wall and which secures the clamping spring on a narrow side against falling out of the housing.

Thus, the wall section forming the clamping spring retaining mechanism can be configured parallel to the front wall in alignment therewith such that the supporting leg or the clamping leg can be placed behind the wall section when mounted from the front wall. This secures it toward the side of the front wall against falling out at least by a positive fit. According to an embodiment which is simple and secure, the wall section forming the clamping spring retaining mechanism can be molded on the housing attachment.

In another embodiment, the housing attachment is dimensioned so that it lies between the supporting leg and the clamping leg when the clamping spring is mounted. This forms a deflection travel limit which limits the deflection travel of the clamping leg when the clamping spring is opened., In this embodiment, the wall section preferably additionally secures the clamping leg in the tensioned state.

According to a further preferred embodiment, a latch hook extends from the rear wall or from another housing section in the receiving chamber in the direction of the front wall. The latch hook has a hook section which covers the supporting leg or another section of the clamping spring, such as the clamping leg or the arc, completely or in sections toward the front wall. This secures the clamping spring toward the front wall against falling out.

Thus, the clamping spring retaining mechanism can be configured as a latch hook molded on the housing, behind which the clamping leg can be latched during mounting.

According to a further preferred embodiment, the conductor insertion channel extends into the region of the clamping space, and a cover section of the front wall substantially covers the conductor insertion channel toward the front wall. The clamping leg can thus be moved in a spring-like manner from the open position into a contacting state, in which it pushes a conductor end against the busbar. It then lies in the contact space between the rear wall and the front wall and is secured by the front wall and the spring retaining mechanism against falling out of the housing.

According to a number of advantageous embodiments, the clamping spring retaining mechanism is integrated into the housing and has been configured by injection molding prior to the clamping spring being inserted into the housing.

Alternatively, the clamping spring retaining mechanism can be integrated into the housing in an embossing manner following the clamping spring being inserted into the housing.

Further, the clamping spring retaining mechanism can be integrated into the housing as an attachment of a busbar or of an otherwise immovable busbar which is inserted into the housing.

It is also an object of the present disclosure to provide an electrical appliance, in particular a terminal block or a plug connector housing which can be arranged in a row, having one or more connection device according to any one of the devices described herein.

### BRIEF DESCRIPTION OF THE DRAWINGS

The invention will be explained in more detail below with reference to the attached drawings on the basis of preferred exemplary embodiments. The invention is not limited to these exemplary embodiments, but rather can be varied and also implemented differently in the context of the claims. In particular, individual features of individual exemplary embodiments can also be combined differently or utilized in other exemplary embodiments, wherein:

FIG. 1a is a side view of a terminal block having two connection devices for connecting conductors;

FIG. 1b is a side partial view of the terminal block from FIG. 1a including one of the connection devices from FIG. 1a;

FIG. 1c is a partial perspective view of the terminal block from FIG. 1a including one of the connection devices from FIG. 1a;

FIG. 1d is a partial enlarged view of the terminal block of FIG. 1c;

FIG. 2a is a front view of a metal and actuation assembly of the terminal block from FIG. 1a;

FIG. 2b is a perspective view of the elements of FIG. 2a;

FIG. 3a is a side view of a terminal block having two connection devices for connecting conductors;

FIG. 3b is a side partial view of the terminal block from FIG. 3a including one of the connection devices from FIG. 3a;

FIG. 3c is a partial perspective view of the terminal block from FIG. 3a including one of the connection devices from FIG. 3a;

FIG. 3d is an enlarged view of the terminal block from FIG. 3c;

FIG. 4a is a side view of a third terminal block having two connection devices for connecting conductors;

FIG. 4b is a partial side view of the terminal block from FIG. 4a including one of the connection devices from FIG. 4a;

FIG. 4c is a partial perspective view of the terminal block from FIG. 4a including one of the connection devices from FIG. 4a;

FIG. 4d is an enlarged view of the terminal block from FIG. 4c;

FIG. 5 is a partial perspective view of a fourth embodiment of a terminal block having at least one connection device for connecting conductors;

FIG. 6 is a partial perspective view of a fifth embodiment of a terminal block having at least one connection device for connecting conductors;

FIGS. 7a and 7b are partial perspective views of a sixth terminal block embodiment having two connection devices for connecting conductors during two different manufacturing steps, respectively; and

FIG. 8 is a partial perspective view of a seventh embodiment of a terminal block having two connection devices for connecting conductors.

### DETAILED DESCRIPTION

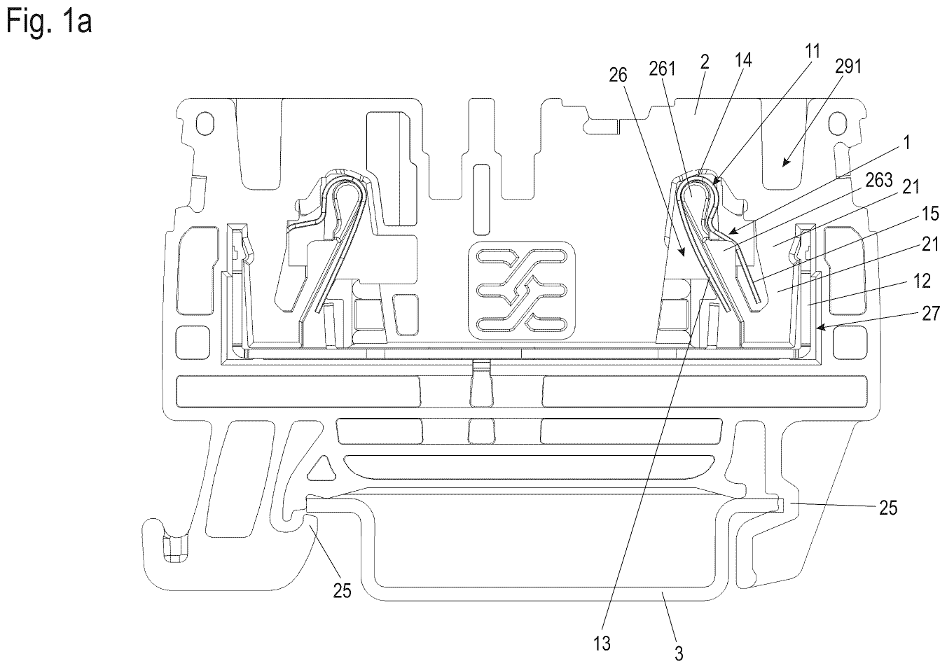

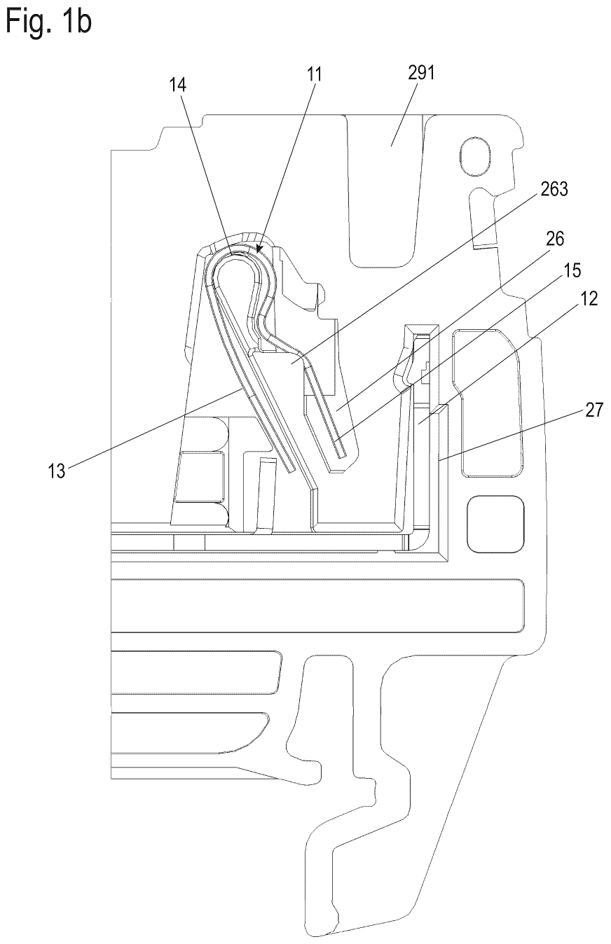

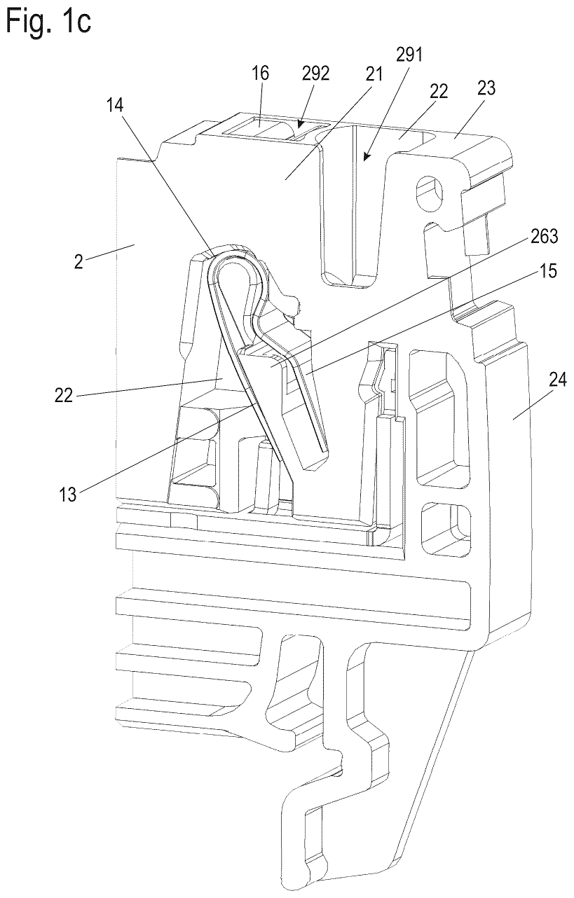

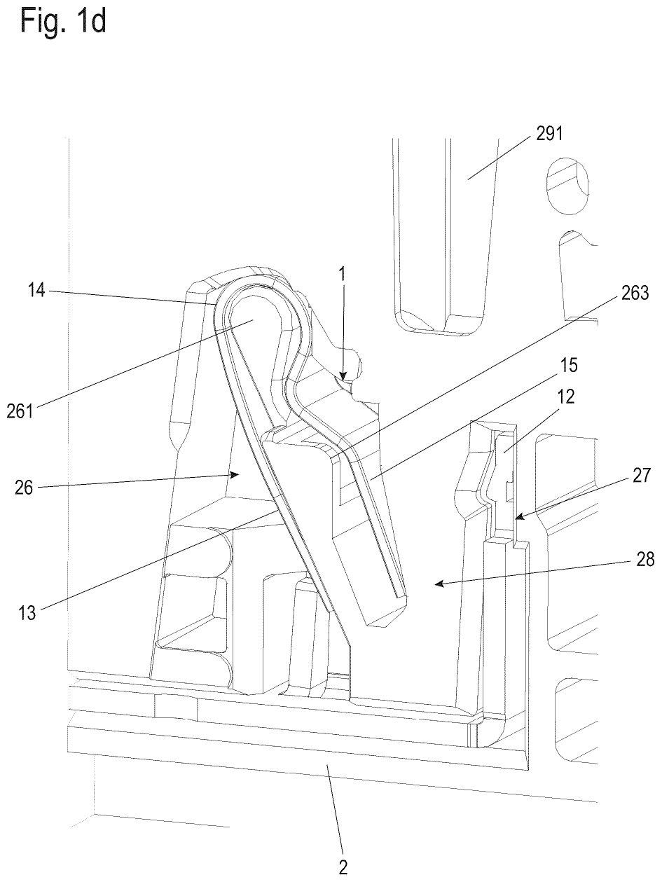

FIGS. 1a, 3a and 4a show side views of an electrical appliance, specifically here a terminal block. The electrical appliance has in each case a housing 2 made of plastic having two connection devices 1 for connecting conductor ends. In a separate embodiment, the electrical appliance could be configured as an electrical appliance other than a terminal block, and the electrical appliance could have only one or more than two connection devices 1.

In the present case, the two connection devices 1 are each configured as part of a single terminal block, in which two of the connection devices 1 provided in a single housing 2 are connected to one another in an electrically conducting manner. However, a connection device within the meaning of this disclosure can alternatively be configured as part of an electrical plug connector which is designed so that it can be arranged in a row, or of another electrical appliance (not depicted here) including a housing 2 having at least one connection device 1. The housing 2 preferably consists of an insulating plastic. One or more of the connection devices 1 can be configured in each housing 2.

A part of the housing 2 having one of the two connection devices 1 is described below. The other can have the same construction or can be constructed symmetrically, for example to a middle plane of the housing 2, relative to the first connection device.

The housing 2 has two main sides which can be arranged in a row, one of which, the front wall 21 here, is configured partly open and the other of which, the rear wall 22 here, can be configured completely or substantially closed. Furthermore, the housing 21 has one or more narrow sides 23, 24 which connect the front side 21 and the rear side 22 (see FIG. 1c).

Fastening mechanism(s) 25, such as retaining feet for fastening the housing 2 onto a mounting base such as a mounting rail 3, can be arranged on the housing.

Each connection device has a clamping spring 11 with which a conductor end can be pressed against an electrically conductive busbar.

The clamping spring 11 can have a substantially V- or U-shaped design and have a supporting leg 13, a clamping leg 15, a spring rear 14 connecting the two legs.

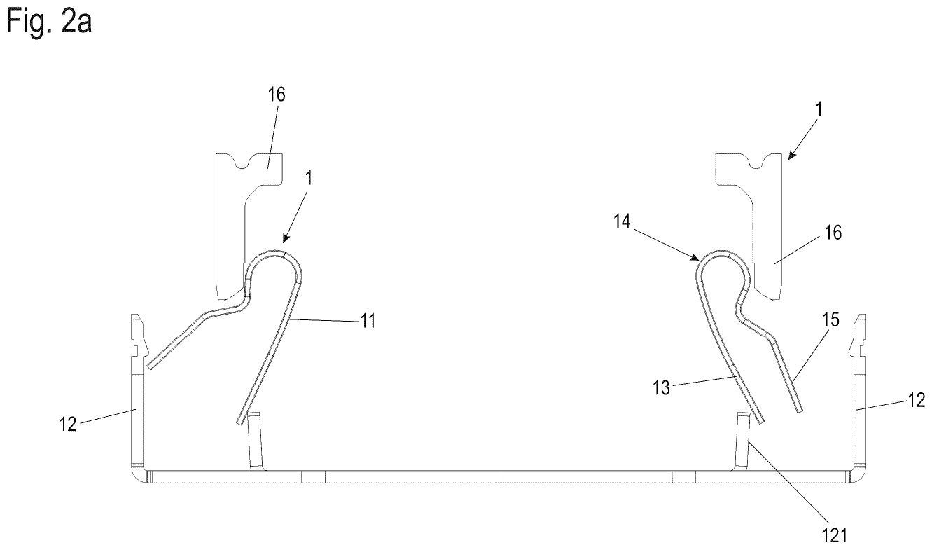

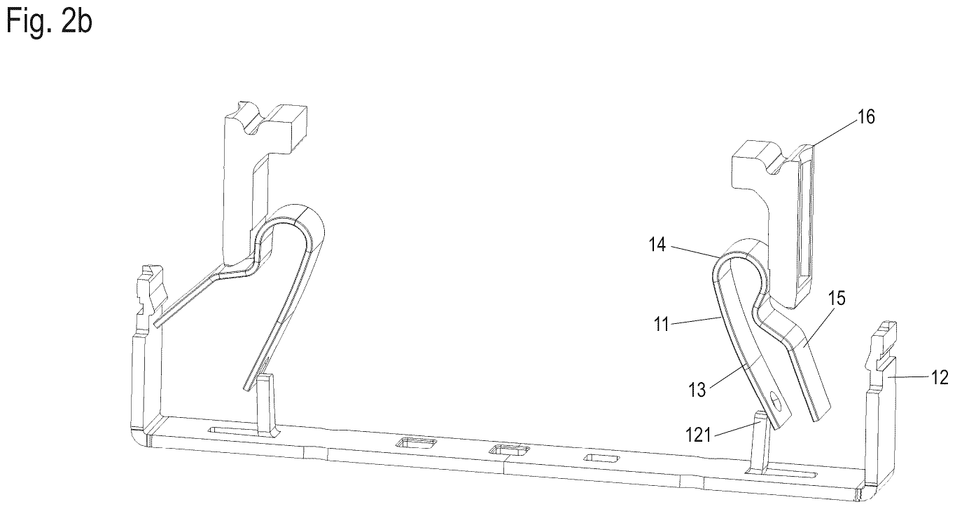

The supporting leg 13 can be supported on an attachment of the housing 2 and/or on another abutment such as an abutment leg 121 bent out from the busbar 12 (see FIG. 2a).

The clamping spring 11 preferably consists of a sheet metal, for example an alloy steel, bent into the V-shape.

One or more receiving chambers 26, 27 extend(s) from the front wall 21 into the housing 2.

One of these receiving chambers 26 is in each case used to insert the respective clamping spring 11 from the front wall 21 into the housing 2. It can also be referred to as a clamping spring receiving chamber 26.

By contrast, another receiving chamber 27 can be used to insert the busbar 12 into the housing 2. It can also be referred to as a busbar receiving chamber 27. The busbar 12 can be produced from a metal strip and is preferably substantially bent into a generally L-shape, and the receiving chamber 27 can similarly have an L-shaped configuration. As shown in FIGS. 2a and 2b, the two L-shaped busbars 12 are busbar sections of an overlapping busbar, which are integrally connected to one another. This results in a feed-through terminal block as shown in FIG. 1a.

The clamping spring 11 is preferably tensioned slightly so that it can be inserted from the front wall 21 into the receiving chamber 26. There, in the inserted state, it preferably overlaps a housing attachment 261, on which it rests with its spring rear 15. The housing attachment 261 can extend like a journal from the rear wall of the housing 2 in the direction of the front wall 21. It can have a length in the row direction such that it extends approximately up to the plane of the front wall 21. The housing attachment 261 can be configured rounded towards the top so that the rounded spring rear 14 rests securely on it. The housing attachment 261 can extend further away from the spring rear 14 in the receiving chamber 26 starting from the section in which the spring rear rests on it. The housing attachment 261 can be dimensioned in the direction of the mounting rail so that it lies between the supporting leg 13 and the clamping leg 15 in the mounted state of the clamping spring 11. It then also forms a deflection travel limit, which limits the deflection travel of the clamping leg 15 when the clamping spring 11 is opened. The housing attachment 261 can also be divided into two sections, between which a slot or the like is configured. The receiving chamber 26 has a generally V-shaped gap due to the housing attachment 261.

Between the receiving chambers 27, 26 for the busbar 11 and the clamping spring 11, there can be a free space 28 between the front wall 21 and the rear wall 22 (in the region below the front wall, 21, in which the arrow of the reference numeral 28 ends). The clamping leg 15 faces this free space 28 with its free end and is opposite the busbar 11. The free space 28 also serves as a contact space in which the clamping leg 15 can push a conductor end against the busbar 12. Once the clamping spring 11 is mounted, the clamping leg 15 moves automatically in the tensioned state in this region which is covered towards the front wall.

Furthermore, one or more channels—here two—are configured in the housing 2. One channel is configured as a conductor insertion channel 291, which extends from a narrow side of the housing 2 (the upper narrow side here) in the housing into the region of the free space 28, so that a conductor end can be guided from the narrow side 23 into the contacting region between the clamping spring 11 and the busbar 12 (see FIG. 1c). The conductor insertion channel 291 can alternatively open toward the front side in one or more sub-regions. For example, the conductor insertion channel 291 can be configured open in a first section starting from the upper narrow side 23 toward the front wall 21 and closed in a further section. This results in a secure insertion of the conductor end into the free space 28. Also, the contacting region in the free space 28 is ensured. The conductor insertion channel 291 is configured so that it is closed to the front wall 21 to such an extent that even a multi-strand conductor can be easily guided into the region of the free and contact space 28. The front wall 21 preferably forms a web-shaped extension and cover of the conductor insertion channel 291, which extends in the insertion direction of the conductor to be clamped up to the clamping space 28 and which is integrally configured with the housing 2.

In order to contact a conductor end, the clamping leg 15 is moved away from the busbar 12, which tensions the clamping spring 11. In this state, the conductor can be guided through the conductor insertion channel 291 into the free and contact space 28 between the free end of the clamping leg 15 and the busbar 12, and between the front wall 21 and the rear wall 22. If the pressure on the clamping leg 15 is released, the clamping leg can relax until the conductor end is pushed against the busbar 12 and contacted.

The clamping leg 15 is preferably opened and tensioned with the aid of an actuation tool, such as a screwdriver or a pre-mounted element of the terminal block. It is formed here by a pusher element 16, which can be made of plastic (see FIGS. 2a, 2b and 1c) and which is arranged here in the actuation channel 292. It can be pushed onto the clamping leg 12 in order to tension the clamping leg and in order to open the clamping site towards the busbar 12, so that a conductor end can be guided into the free space 28 (see FIGS. 2a and 2b).

This construction of this type of connection device is simple and cost-effective.

In order to prevent the clamping spring 11 from falling laterally out of the receiving chamber 26 and out of the housing 1 towards the front wall 21 (for example in the tensioned state of the clamping leg where it can align with the receiving opening), a clamping spring retaining mechanism 263 integrated into the housing 2 is provided, as shown in each of the embodiments of FIGS. 1a, 3a and 4a, as well as 5, 7a, 7b and 8. This can be configured in particular in the region of the receiving chamber 26. The clamping spring retaining mechanism 263 can be integrally configured with the housing 2, which is particularly simple, cost-effective and secure. However, it can also be arranged separately from the housing 2 and attached to it, for example by clamping or with adhesive, or it can be inserted into it.

The clamping spring retaining mechanism 263 is preferably configured as an integral section of the housing 2, which additionally secures the clamping leg 15, the supporting leg 13 or the spring rear 14 towards the front wall 21 against falling out of the receiving chamber. It does this by covering one of these elements towards the front side, temporarily or, preferably, constantly, whether the clamping state or opening state.

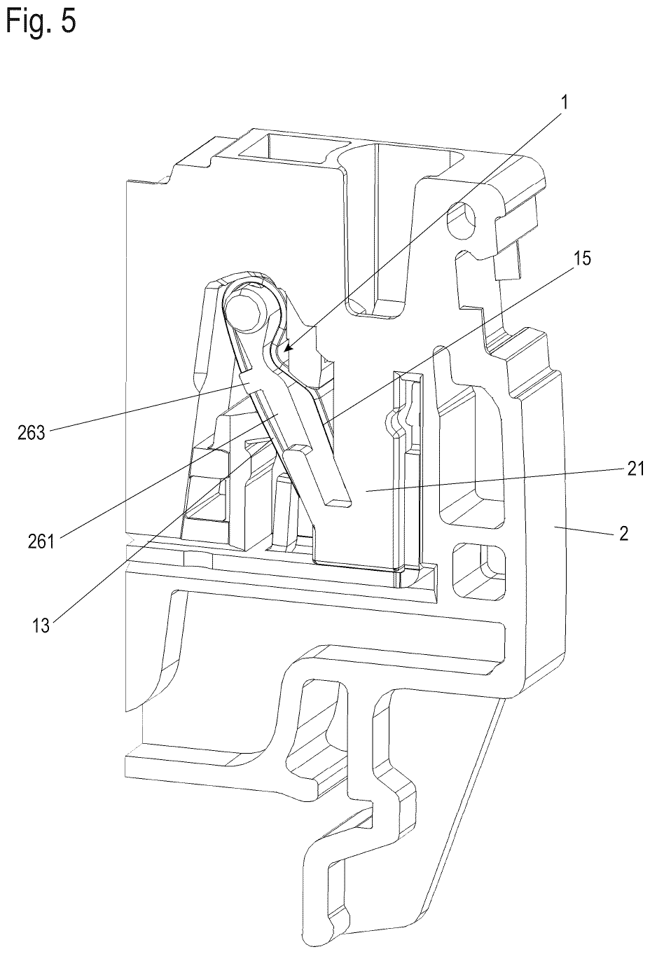

Thus, the clamping spring retaining mechanism 263 can be configured and arranged as a wall piece, for example substantially parallel to the front wall 21, in alignment therewith and/or connected thereto. This is so that the supporting leg 13 or the clamping leg 15 can be placed behind the housing attachment 263 during mounting, for example in the region of a bend (see in particular FIGS. 1b and 1d or 5), which positively secures it toward the side of the front wall 21 against falling out. This also secures it in a state in which the clamping leg has been tensioned so far that it would not otherwise be positively held toward the front wall 21 in the mounting and receiving chamber 26.

FIGS. 1a-1d show such a first embodiment. Here, the clamping spring retaining mechanism 263 is molded on the housing attachment 261 as a continuation of the front wall 21. The clamping leg 15 can be placed behind this during mounting so that it is secured toward the front wall 21 against falling once mounted. If the housing attachment 261 is dimensioned so that it lies between the supporting leg 13 and the clamping leg 15 in the mounted state of the clamping spring 11 and also forms a deflection travel limit which limits the deflection travel of the clamping leg 15 when the clamping spring is opened. The wall section 263 in this region of the housing attachment 261 is configured in the direction of the clamping leg 15 and secures the clamping leg 15 well in the tensioned state.

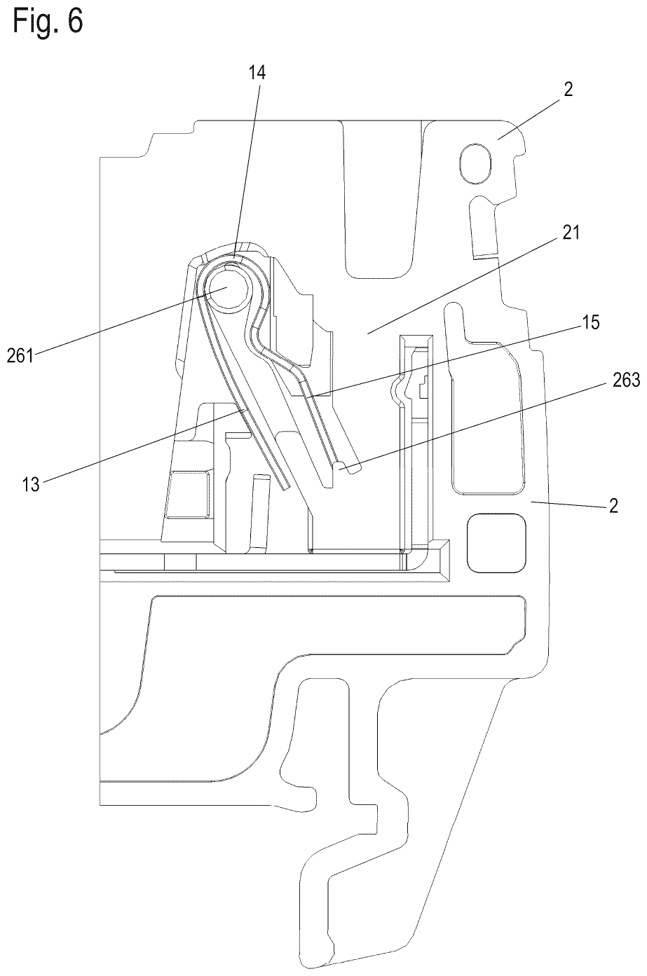

FIG. 6 shows a similar embodiment. Here, the clamping spring retaining mechanism 263 includes a protrusion-like continuation of the front wall 21. The clamping leg 15 can be placed behind this when mounted so that it is secured toward the front wall 21 against falling out in the tensioned “open” state. As shown in FIG. 6, securing takes place toward the free end of the clamping leg 15 as opposed to the free end.

Referring to FIGS. 1a-1d, 5 or 6, the protrusion-like continuation 263 can also be molded during injection molding of the housing so that when it is mounted, the clamping spring is placed behind this protrusion-like continuation 263 with one of its functional elements, such as the clamping leg 15.

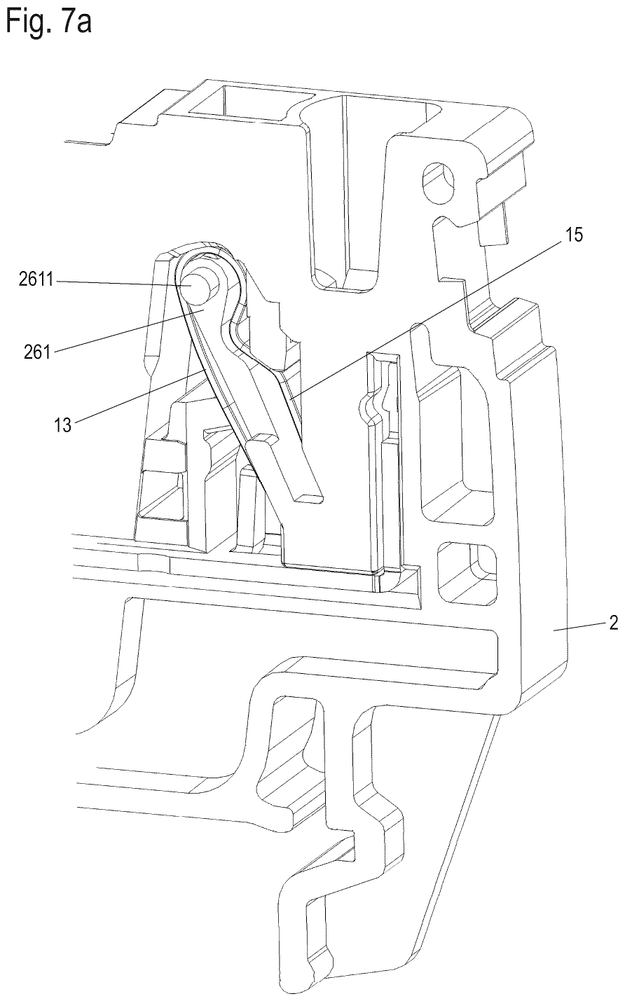

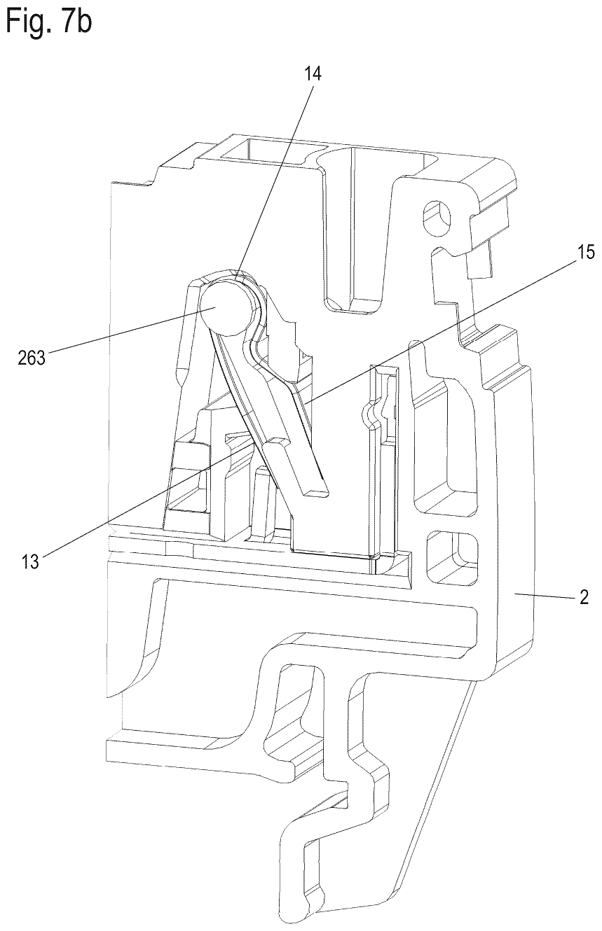

As shown in FIGS. 7a and 7b, it is also conceivable for the protrusion-like continuation 263 to not be molded until after the housing has been injection molded and after the clamping spring 11 has been inserted. Thus, the housing attachment 261 has an injection-molded extension 2611 (FIG. 7a) in the manner of a housing journal toward the front wall, which is reshaped in an embossing manner (e.g., with a hot stamp) following insertion of the clamping spring 11. The extension is reshaped into a kind of ring wall, behind which the spring rear 15 is well secured against falling out, as shown in FIG. 7b.

FIG. 5 shows a similar embodiment with the clamping spring retaining mechanism 263 molded on the housing attachment 261 as a continuation of the front wall 21. In this instance, the clamping leg 15 is not placed behind this when mounted, but rather the supporting leg 13 is so that it is secured towards the front wall 2 against falling out.

It is likewise conceivable for the clamping spring retaining mechanism 263 to secure both the supporting leg 13 and the clamping leg 15, and if necessary the spring rear 14, against falling.

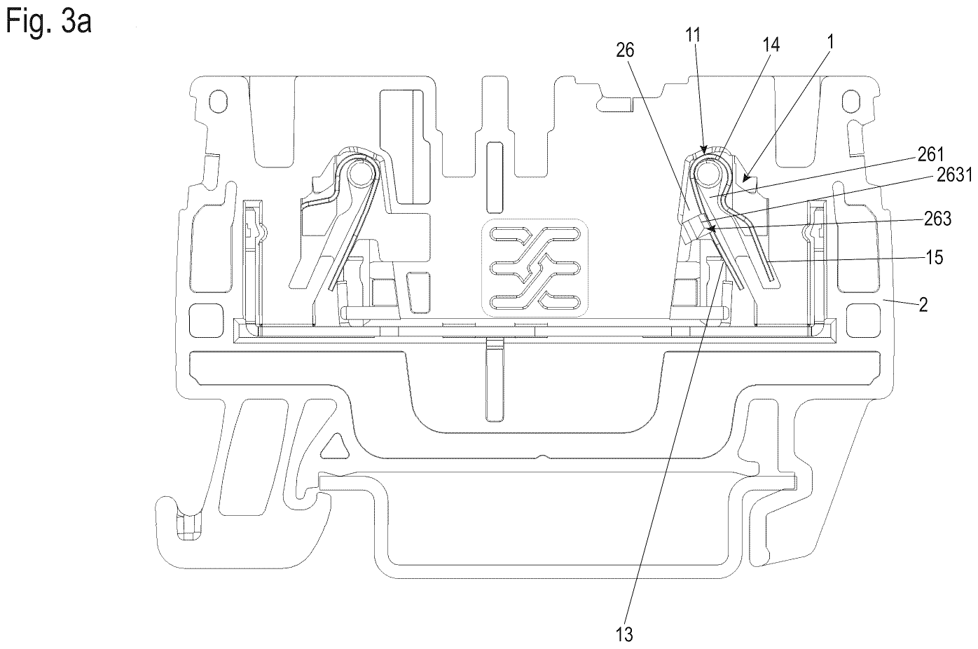

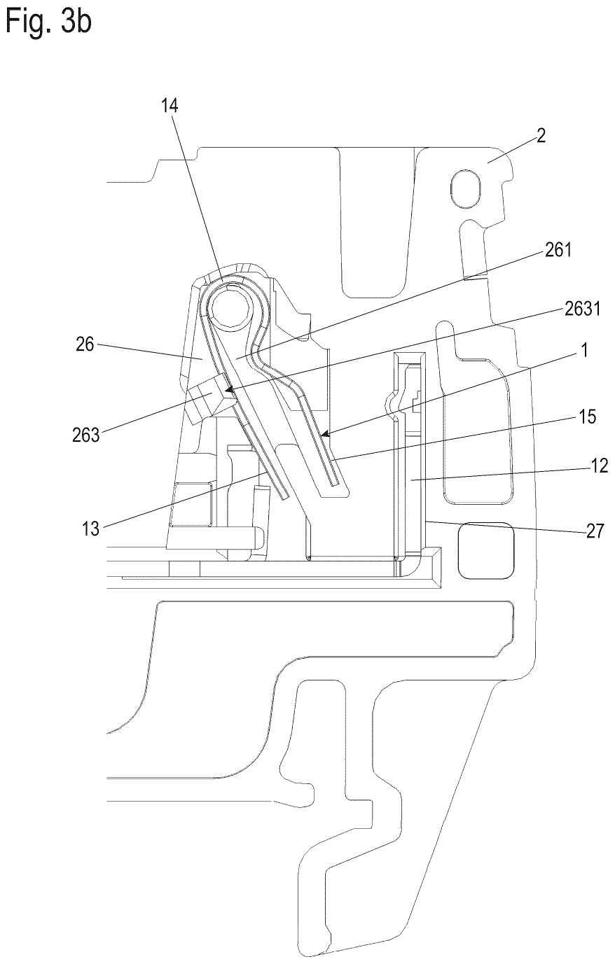

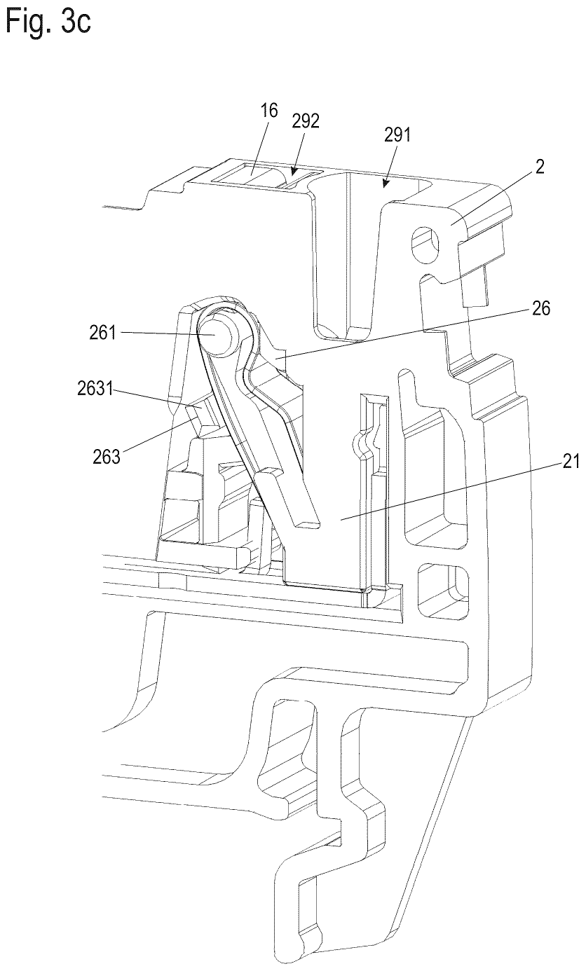

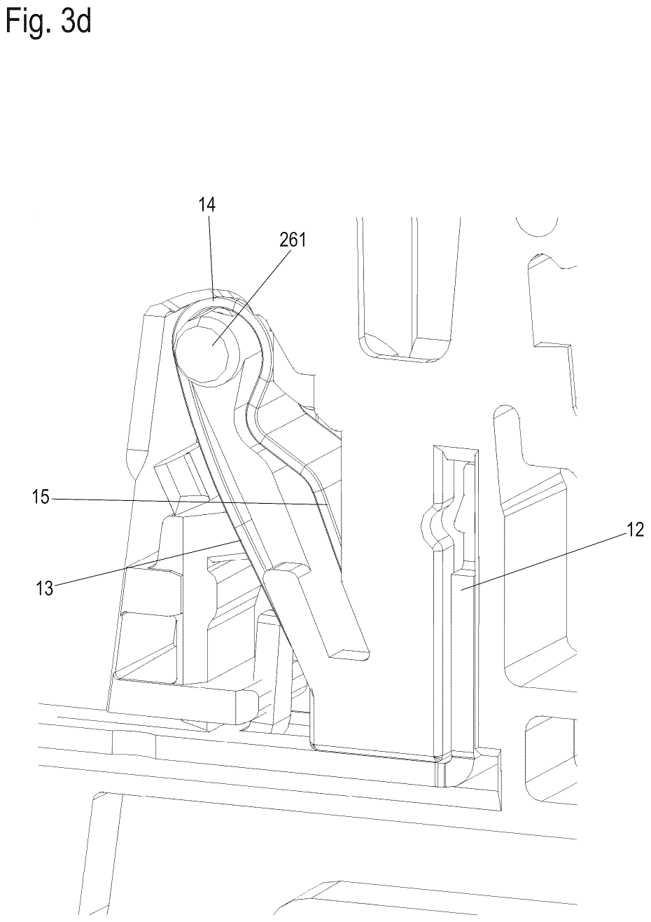

Alternatively, the clamping spring retaining mechanism 263 can also be configured as a hook, in particular as a latch hook 2631, which can be integrally configured with the housing and preferably in the housing 2 (see FIGS. 3a-3d and FIGS. 4a-4d and 8). According to one embodiment, the latch hook 2631 extends from the rear wall 22 or from another housing section, such as the housing attachment in the receiving chamber 26, in the direction of the front wall. There is also a hook section which covers and grips, completely or in sections, the supporting leg 13 and/or another section of the clamping spring 11 such as the clamping leg 15 or the spring rear 14 towards the front wall 21. In turn, this positively, and if necessary non-positively, secures the clamping spring 11 well toward the front wall 21 against falling out.

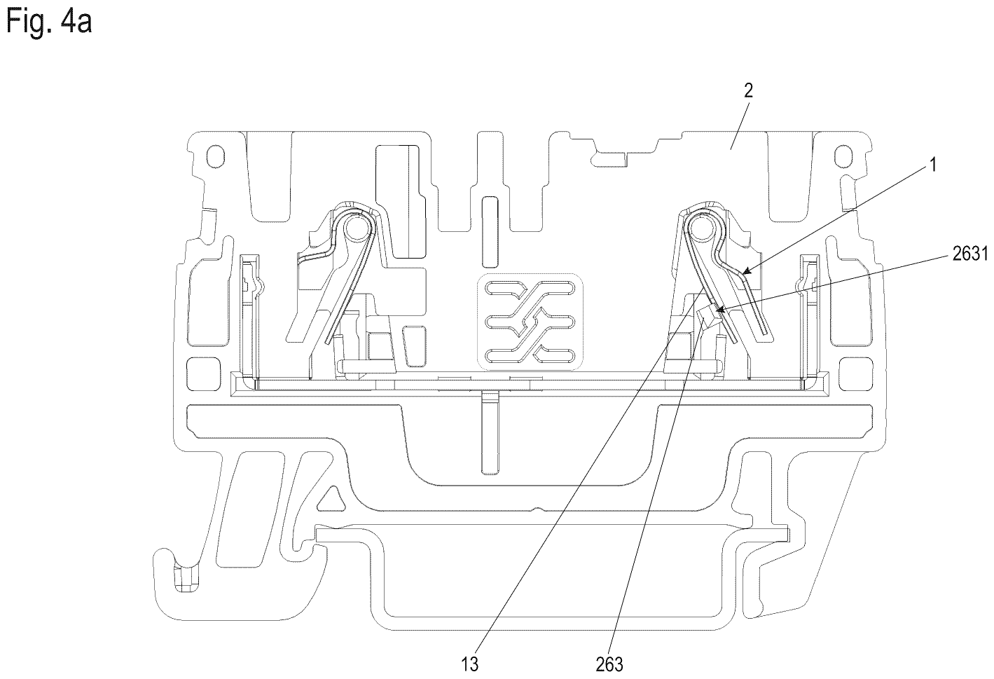

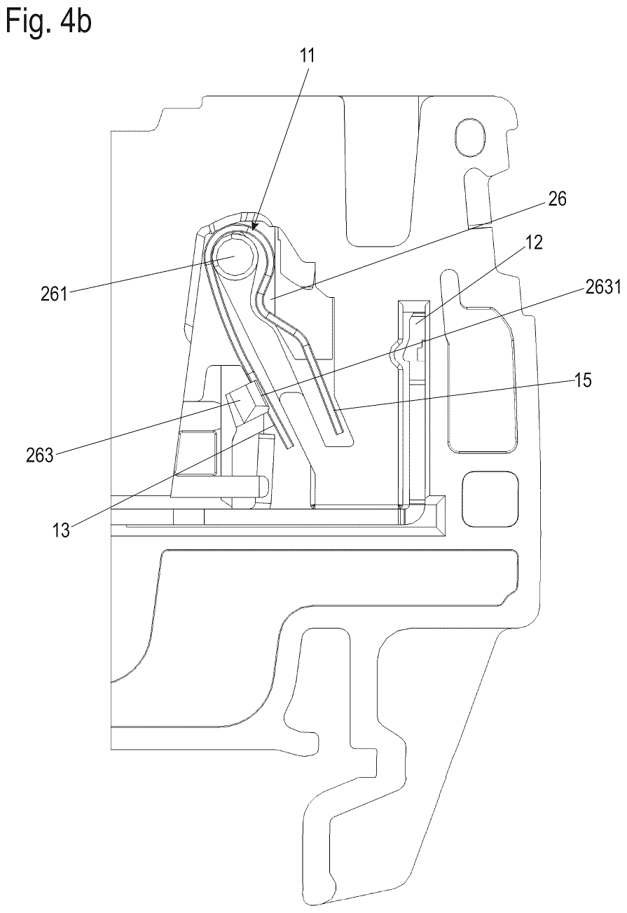

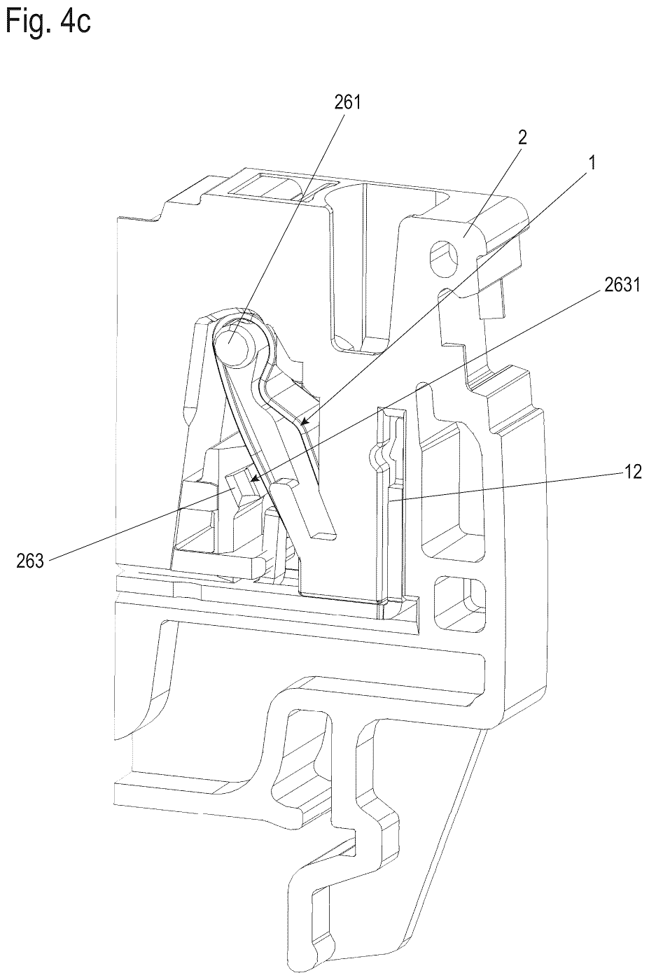

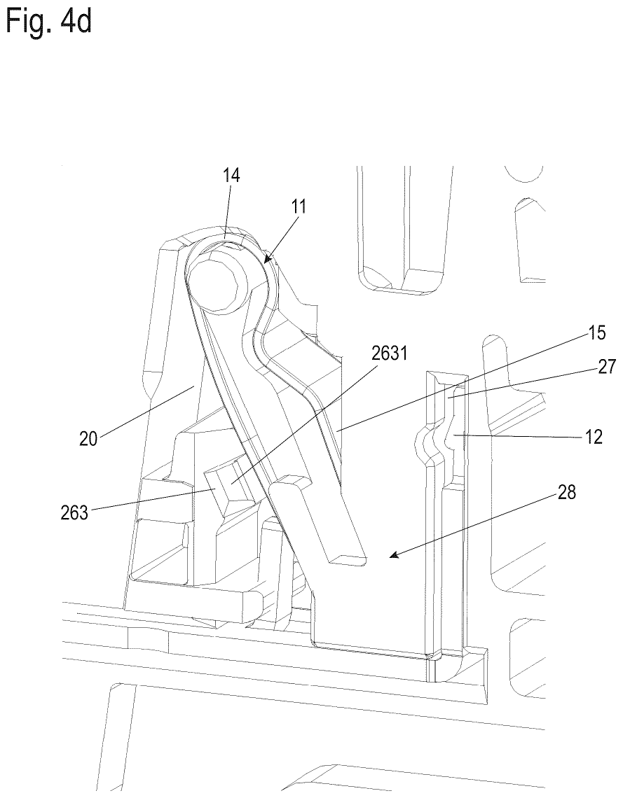

According to FIGS. 3a-3d and 4a-4d, the latch hook 2631 attaches at different points of the housing and engages the narrow side of the supporting leg 13 at various points in a latching manner. The narrow side faces the open side of the receiving chamber 26 or the front wall 21. Further variants of an arrangement of this latch hook 2631, which are not depicted here, are likewise conceivable.

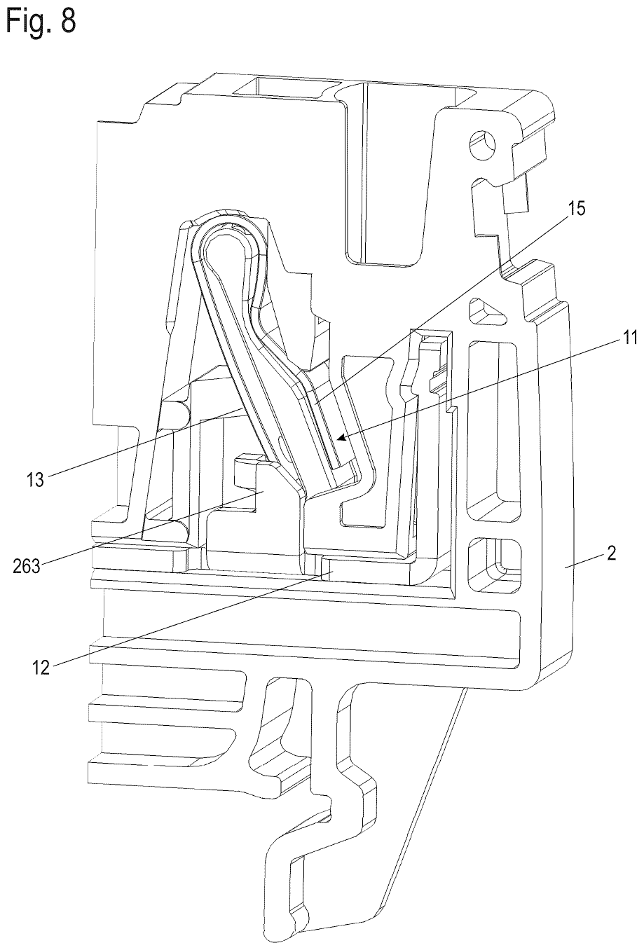

Finally, according to FIG. 8, the clamping spring retaining mechanism 263 is configured in the housing 2 similar to a clamping cage as a section of the busbar 12, which substantially aligns with the front wall 21, and which preferably covers and grips, completely or in sections, the supporting leg 13 and/or the clamping leg 14 toward the front wall 21. This in turn secures the clamping spring 11 toward the front wall 21 against falling out after the clamping spring has been inserted into the housing 2.

What is claimed is:

1. A connection device for connecting a conductor end, comprising:
a. a housing having a rear wall and a front wall, a busbar being arranged in the housing;
b. a V-shaped clamping spring arranged in the housing having a supporting leg supported on an abutment, a clamping leg and a spring rear connecting the supporting and clamping legs;
c. a conductor insertion channel configured in the housing to guide a conductor end to be connected into a contacting space between the front wall and the rear wall;
d. the housing containing a receiving chamber open toward the front wall of the housing for inserting and for receiving the clamping spring, a housing attachment overlapped by the clamping spring being configured therein; and
e. the housing having a clamping spring retaining mechanism to positively secure the clamping spring against falling out of the receiving chamber towards the front wall, including in a state in which the clamping leg is in an open position.

2. The connection device according to claim 1, wherein the clamping spring retaining mechanism is integral with the housing.

3. The connection device according to claim 1, wherein the clamping spring retaining mechanism includes a wall section of the housing being connected to the front wall and securing the clamping spring on a narrow side against falling out of the housing, the clamping spring comprising a sheet metal.

4. The connection device according to claim 1, wherein the clamping spring retaining mechanism includes a wall section of the housing not being directly connected to the front wall and securing the clamping spring on a narrow side against falling out of the housing, the clamping spring comprising a sheet metal.

5. The connection device according to claim 3, wherein the clamping spring retaining mechanism wall section is arranged parallel to the front wall in alignment therewith to allow one of the supporting leg and the clamping leg to be placed behind the wall section when mounted to positively secure it toward the side of the front wall against falling out.

6. The connection device according to claim 5, wherein the clamping spring retaining mechanism wall section is molded on the housing attachment in the receiving chamber.

7. The connection device according to claim 5, wherein the housing attachment is configured to be arranged between the supporting leg and the clamping leg when the clamping spring is mounted, wherein the housing attachment limits the deflection travel of the clamping leg when the clamping spring is opened, the wall section being configured in the region of the housing attachment to secure the clamping leg in the tensioned state.

8. The connection device according to claim 1, wherein the clamping spring retaining mechanism includes a latch hook molded on the housing, the clamping leg being latched behind the latch hook when mounted.

9. The connection device according to claim 8, wherein the latch hook extends from one of the rear wall and another housing section in the receiving chamber in the direction of the front wall, the latch hook having a hook section completely covering or covering in sections one of the supporting leg and another section of the clamping spring including the clamping leg or the supporting leg toward the front wall to secure the clamping spring toward the front wall against falling out.

10. The connection device according to claim 1, wherein the conductor insertion channel extends into the region of the contacting space and is substantially covered by a cover section of the front wall the clamping leg being movable in a spring-like manner from the open position into a contacting state to push a conductor end against the busbar to the contact space between the rear wall) and the front wall to be secured by the front wall in the receiving space by the spring retaining mechanism against falling out of the housing.

11. The connection device according to claim 1, wherein the front wall includes a web-shaped extension of the conductor insertion channel integrally configured with the housing and extending in the insertion direction of a conductor to be arranged in the clamping space.

12. The connection device according to claim 1, wherein the clamping spring retaining mechanism is integrated into the housing by injection molding prior to the clamping spring being inserted into the housing.

13. The connection device according to claim 1, wherein the clamping spring retaining mechanism is integrated into the housing an embossing manner following the clamping spring being inserted into the housing.

14. The connection device according to claim 1, wherein the clamping spring retaining mechanism is integrated into the housing as an attachment of the busbar inserted into the housing.

15. An electrical appliance being one of a terminal block and a plug connector housing configured to be arranged in a row comprising one or more connection device according to claim 1.
